(19) United States
(12) Patent Application Publication
(10) Pub. No.: US 2017/0075827 A1
(43) Pub. Date: Mar. 16, 2017

(54) I/O COMMAND ID COLLISION AVOIDANCE IN A MEMORY DEVICE

(71) Applicant: Avago Technologies General IP (Singapore) Pte. Ltd., Singapore (SG)

(72) Inventors: Robert E. Ward, Colorado Springs, CO (US); Brian Lessard, Colorado Springs, CO (US)

(21) Appl. No.: 14/852,111

(22) Filed: Sep. 11, 2015

(51) Int. Cl. G06F 13/16; G06F 13/368

(52) U.S. Cl. CPC G06F 13/1668; G06F 13/368

(57) ABSTRACT

Embodiments herein provide for avoiding ID collisions in a memory device. In one embodiment, a memory device includes slave logic operable to receive I/O commands from a plurality of master components and a memory controller operable to process the I/O commands from the master components to operate on data in the memory. Each I/O command comprises an ID assigned by its originating master component. The slave logic is further operable to determine the ID of a first I/O command from a first of the master components, to receive a second I/O command from a second of the master components having a same ID as the first I/O command while the first I/O command is being processed by the memory controller, and to stall the second I/O command until the first I/O command is complete while allowing other I/O commands with other IDs to access the memory.

### FIELD

The invention generally relates to memory devices.

### BACKGROUND

A memory device often comprises logic that manages the flow of data going to and from a memory array. Often, the memory device includes a memory controller that processes Input/Output (I/O) commands to address specific memory locations in the memory array to read data from and write data to the array. Depending on the command set of the memory controller, the I/O commands can implement write operations through different ways. For example, a read-modify-write I/O command directs the memory controller to read a memory location and then write a new value to that location at once, either with a completely new value or some function of the previous value. In some instances, the memory device is accessible from multiple master components/devices through slave logic. And, those master components can assign their own identifications (IDs) with each I/O command issued to the memory device, leaving the slave logic with potential ID collisions that can prevent the I/O commands from operating on data in the memory device.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary memory device operable with a plurality of master devices.

FIG. 2 is a flowchart of an exemplary process of the memory device of FIG. 1.

FIG. 3 is a more detailed block diagram of the exemplary memory device of FIG.

FIG. 4 is a flowchart exemplarily illustrating clock cycle looping for I/O command ID collision avoidance.

FIG. 5 is an exemplary state machine operable with the memory device of FIG. 1.

FIG. 6 illustrates an exemplary computer system operable to execute programmed instructions to perform desired functions.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

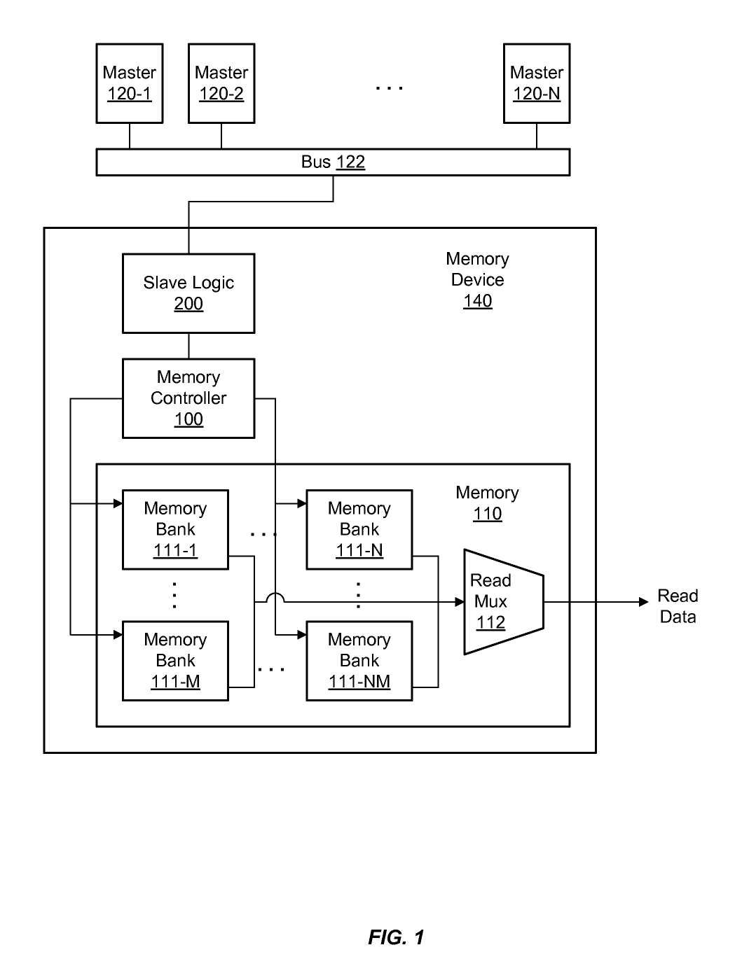

FIG. 1 is a block diagram of an exemplary memory device 140 operable with a plurality of master devices 120-1-120-N (where the reference number “N” merely represents an integer greater than “1” and not necessarily equal to any other “N” reference designated herein). In this embodiment, the memory device 140 employs slave logic 200 to interface with the master devices 120 through a computer bus 122.

The slave logic 200 is operable to receive and buffer read I/O commands and various forms of write I/O commands, including I/O commands that perform read-modify-write operations. Generally, I/O commands from the master devices 120 are processed in the order that they are received. Each of the I/O commands comprises an identification (ID) assigned by its originating master device. The slave logic 200 is operable to determine the IDs of the I/O commands so as to prevent ID collisions.

For example, master devices assign IDs to each of the I/O commands issued to the memory device. As master devices generally do not keep track of how other master devices assign IDs, the slave logic 200 is likely to receive I/O commands with the same ID. The slave logic 200 thus extracts IDs from each of the I/O commands received and determines whether any given ID exists with an I/O command presently being processed, more specifically an I/O command operable to perform a read-modify-write operation in the memory 110. If an I/O command with the same ID is being processed, the slave logic 200 stalls the later I/O command until the “in-progress” I/O command is complete. In this regard, the slave logic 200 is any device, system, software, or combination thereof operable to prevent ID collisions when multiple master devices issue I/O commands with the same IDs.

A memory controller 100 processes the I/O commands to specific locations in the memory 110. For example, each I/O command may have an address of a memory bank 111 in the memory 110 to where data is to be operated on. The memory controller 100 is any device, system, software, or combination thereof operable to process I/O commands to access memory locations in the memory 110 for read and write operations. In processing the I/O commands, the memory controller 100 determines an address within each I/O command that directs the read/write operation to a specific location in one of the memory banks 111-1-111-NM (where the reference number “M” merely represents an integer greater than “1” and not necessarily equal to any other “M” reference designated herein).

The memory controller 100 is operable to determine the order in which the I/O commands are processed is operable to “load” the I/O commands in the order that they are received so as to process the various read/write operations of the commands. For example, the memory controller 100 may load a write I/O command that writes to a specific address in one of the memory banks 111. Then, the memory controller 100 may load a read I/O command that reads from a specific address of the memory banks 111. Once read, the data is output from the memory 110 through a read multiplexer 112. Another example of an operation that may be formed via the I/O commands includes a read-modify-write operation that reads data from a location in the memory 110. The read-modify-write operation then writes a new value at that location in one clock cycle, either with a completely new value or some function of the previous value, as mentioned.

In this embodiment, the slave logic 200 and the memory controller 100 are configured “on-chip” with the memory 110. Generally, the slave logic 200 and the memory controller 100 are operable with various forms of data storage devices used to implement the memory 110. Some examples of the memory 110 include static random access memory (SRAM) and dynamic random access memory (DRAM).

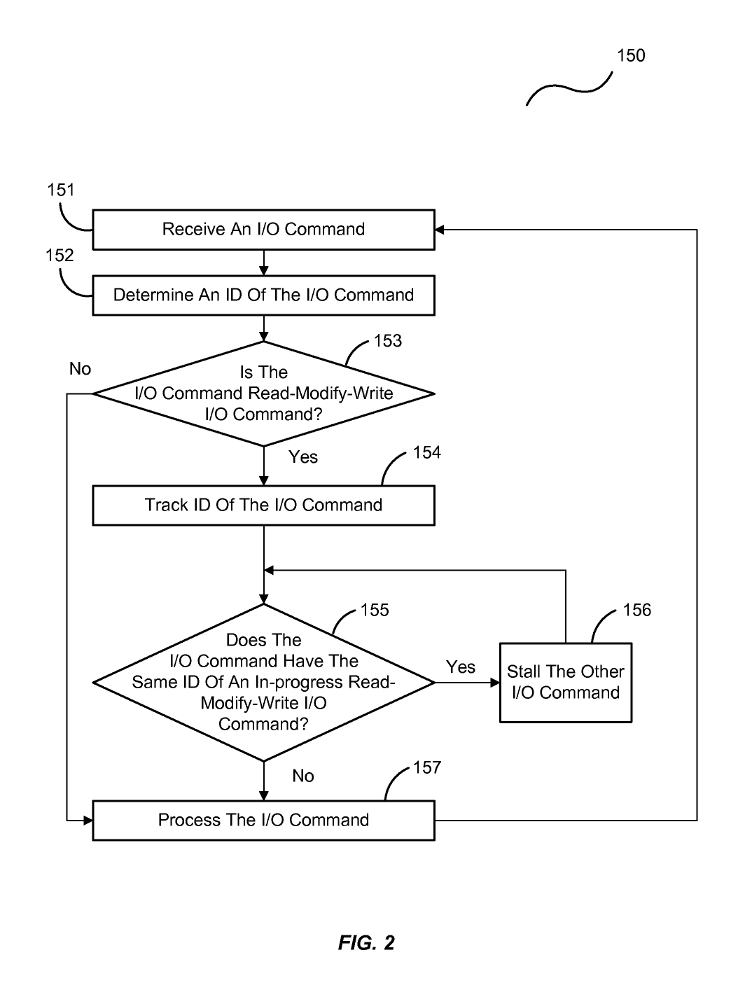

FIG. 2 is a flowchart of an exemplary process 150 of the slave logic 200. In this embodiment, the slave logic 200 receives an I/O command, in the process element 151, and determines an ID of the I/O command, in the process element 152. The slave logic 200 and then determines whether the I/O command is a read-modify-write I/O command that is operable to perform a read-modify-write operation in the memory 110, in the process element 153. If the I/O command is a read-modify-write I/O command, then the slave logic 200 tracks the ID of the I/O command, in the process element 154. If the I/O command is not a read-modify-write I/O command, the slave logic 200 allows processing of the I/O command (e.g., by the memory controller 100), in the process element 157.

After tracking the ID of the read-modify-write I/O command, in the process element 154, the slave logic 200 determines whether the I/O command has the same ID of any in-progress read-modify-write I/O command, in the process element 155. If so, the slave logic 200 stalls the other I/O command, in the process element 156, and loops until the previous read-modify-write I/O command is complete. Once the previous read-modify-write I/O command is complete, the slave logic 200 transfers the next read-modify-write I/O command to the memory controller 100 for processing and tracks the ID of that read-modify-write I/O command until it is complete.

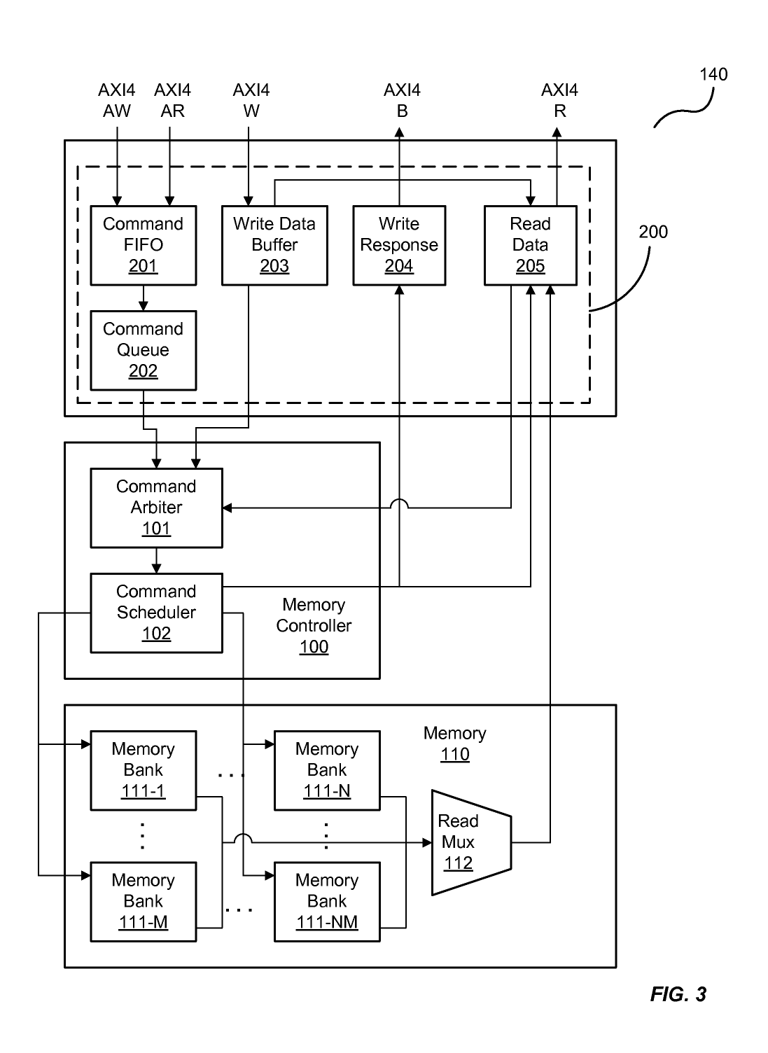

FIG. 3 is a block diagram of another exemplary memory controller 100. In this embodiment, the memory controller 100 is integrated “on chip” with the memory 110 and configured with the slave logic 200 in an ARM Advanced Microcontroller Bus Architecture (AMBA). The slave logic 200 uses Advanced eXtensible Interface (AXI) 4, the fourth generation of the AMBA interface specification, to interface with a plurality of master I/O devices (e.g., master devices 120 of FIG. 1). The slave logic 200 comprises, among other things, a command FIFO (First In First Out) buffer 201, a write data buffer 203, write response logic 204, a read data controller 205, and a command queue 202.

The command FIFO buffer 201 is operable to receive and buffer read I/O commands (via an AXI4 AR interface) and various forms of write I/O commands (via an AXI4 AW interface), including read-modify-write operations. Data associated with the write commands is processed through the write data buffer 203 (via an AXI4 W interface). The I/O commands are queued for processing in the command queue 202. Once a write I/O command is processed and the data is written to the memory 110, the write response logic 204 replies to the appropriate master device issuing the I/O command (via an AXI4 B interface). Similarly, when a read I/O command is processed and the data is read from the memory 110, the data is transferred from the memory 110 (via the read multiplexer 112) to the appropriate master device issuing the I/O command (via an AXI4 R interface).

The command FIFO buffer 201 receives I/O commands from the master devices 120 such that they may be processed in the order that they are received. Each of the I/O commands comprises an identification (ID) assigned by its originating master device 120. The command queue 202 is operable to determine the IDs of the I/O commands so as to prevent ID collisions.

For example, master devices 120 assign IDs to each of the I/O commands issued to the memory device 140. Again, because master devices generally do not keep track of how other master devices assign IDs, the command FIFO buffer 201 is likely to receive I/O commands with the same ID. The command queue 202 thus extracts IDs from each of the I/O commands received and determines whether any given ID exists with a read-modify-write I/O command presently being processed. If a read-modify-write I/O command with the same ID is being processed, the command queue 202 determines whether the subsequent I/O command is also a read-modify-write command. If so, the command queue 202 stalls the subsequent I/O command until the in-progress I/O command is complete. Otherwise, the command queue 202 to assess the subsequent I/O command to the memory controller 100 for processing.

In other words, the command queue 202 is operable to receive a first read-modify-write I/O command from a first master device 120 while a second read-modify-write I/O command is presently operating on data in the memory 110. The second read-modify-write I/O command is from a second different master device 120 but has the same ID as the first read-modify-write I/O command. The command queue 202 stalls the first read-modify-write I/O command until the second read-modify-write I/O command is complete. In the meantime, the command queue 202 tracks the ID of the second read-modify-write I/O command until the second read-modify-write I/O command is complete. And, if a third I/O command is received by the command FIFO 201 and that I/O command is not a read-modify-write, the command queue 202 allows the third I/O command to be processed by the memory controller 100 regardless of its ID even while the first I/O command is in progress.

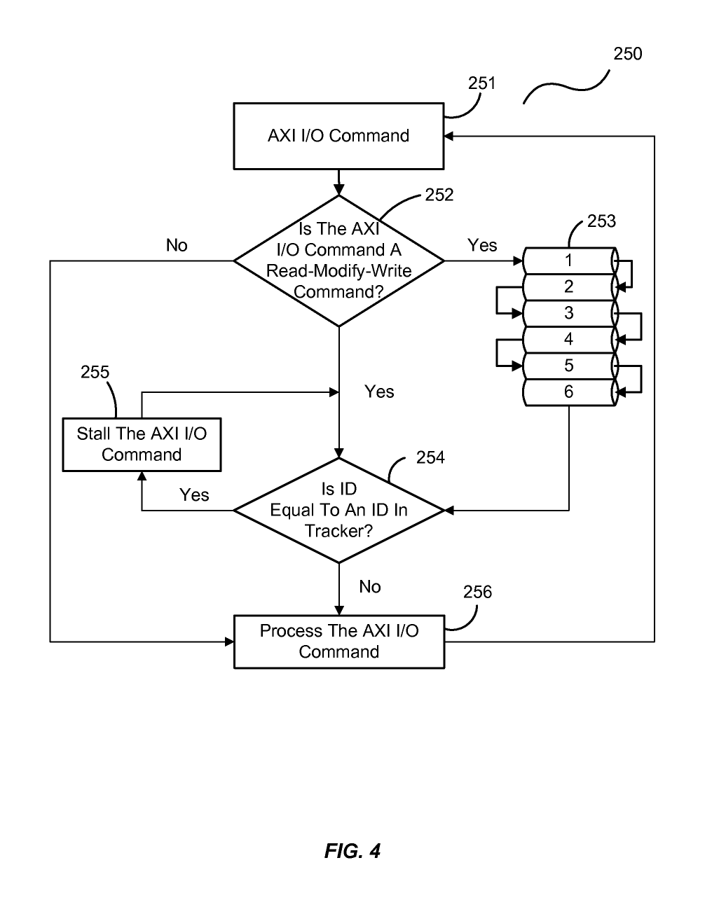

FIG. 4 is a flowchart of a process 250 exemplarily illustrating ID tracking for AXI I/O commands. In this embodiment, the command FIFO 201 of the slave logic 200 (FIG. 3) receives an AXI I/O command, in the process element 251, and then determines whether the AXI I/O command is a read-modify-write I/O command, the process element 252. If so, the command queue 202 loads the ID of the AXI I/O command into the ID tracker 253 where it is retained until the read-modify-write operation of the AXI I/O command is processed. Additionally, the command queue 202 determines whether the ID is equal to an ID already existing in the ID tracker 253, in the process element 254. If the AXI I/O command is not an AXI read-modify-write I/O command, then the command queue 202 allows the AXI I/O command to be processed by the memory controller 100, in the process element 256.

If the AXI I/O command comprises an ID that is the same as an ID existing in the ID tracker 253 and the I/O command is a read-modify-write command, then the command queue 202 stalls the subsequent AXI I/O command, in the process element 255 and loops until the ID of the previous AXI read-modify-write I/O command is complete. Otherwise, the command queue 202 allows the AXI read-modify-write I/O command to be processed by the memory controller 100, in the process element 256.

To illustrate, suppose a first master device 120-1 (i.e., of FIG. 1) issues an AXI read-modify-write I/O command to the memory device 140. That I/O command will have an ID associated with it as assigned by the master device 120-1. The command FIFO 201 will intake that I/O command and transfer it to the command queue 202 on a first in first out basis. Then, suppose a second master device 120-2 issues an AXI read-modify-write I/O command to the memory device 140 with an ID that is the same as that issued by the first master device 120-1. The command queue 202 will load the ID of the first I/O command into the ID tracker 253 and allow it to be processed by the memory controller 100. The command queue 202 will inspect the AXI read-modify-write I/O command from the second master device 120-2, load its ID into the ID tracker 253, and determine whether another matching ID exists in the ID tracker 253. As the first AXI read-modify-write I/O command is being processed, its ID will remain in the ID tracker 253 until it is complete. The command queue 202 will stall the second AXI read-modify-write I/O command from the second master device 120-2 until the previous AXI read-modify-write I/O command from the first master device 120-1 is complete and its ID has been flushed from the ID tracker 253. If a third AXI I/O command is received by the command FIFO 201 from another master device 120-3 and that I/O command is, for example, a read I/O command, then the command queue 202 allows the third AXI I/O command to be processed by the memory controller 100 regardless of its ID.

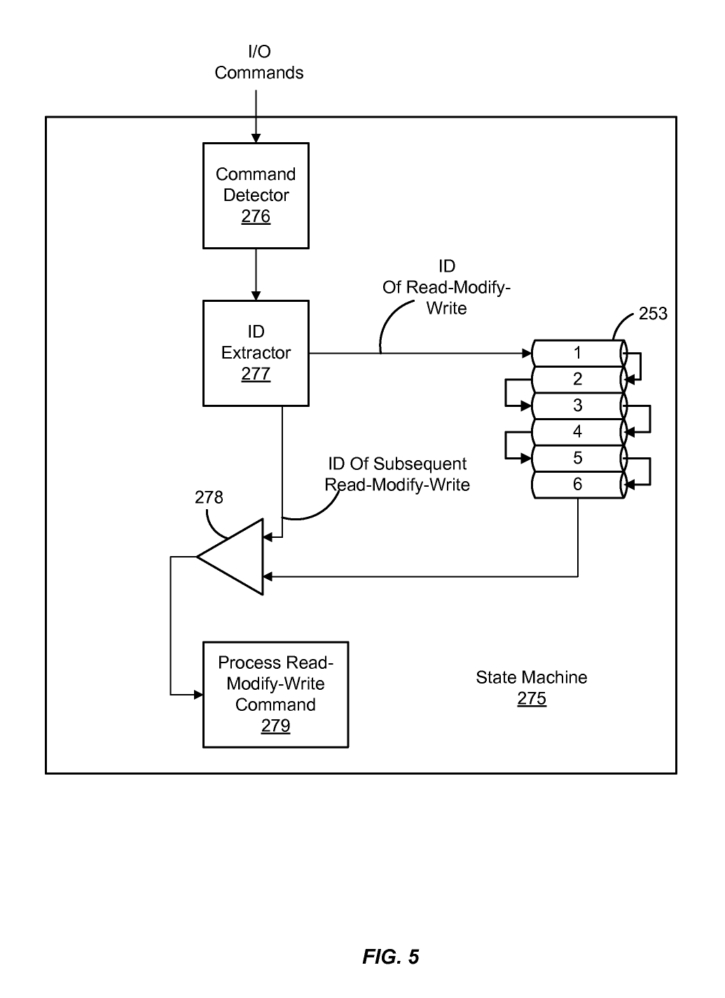

FIG. 5 is an exemplary state machine 275 operable with the command queue 202. In this embodiment, the command queue 202 receives the AXI I/O commands from the command FIFO 201 and inspects the I/O commands via command detector logic 276 to determine whether the commands are read-modify-write I/O commands. For those AXI I/O commands that are read-modify-write I/O commands, ID extractor logic 277 extracts the ID and transfers it to the ID tracker 253 where it remains until the read-modify-write operation of the AXI I/O command is complete.

As illustrated, the ID tracker 253 comprises six buffers corresponding to the number of cycles it will take for a read-modify-write operation to complete. Accordingly, for any subsequent AXI read-modify-write I/O command, the ID that is extracted from the subsequent command is compared via the comparator 278 to the ID existing in the ID tracker 253. If no matching ID exists in the ID tracker 253, the comparator 278 allows the subsequent AXI read-modify-write I/O command to be processed by the memory controller 100 (in the process element 279). Otherwise, the subsequent AXI read-modify-write I/O command is stalled until the previous AXI read-modify-write I/O command is complete.

It should be noted that the invention is not intended to be limited to the number of clock cycles it takes to process an I/O command. The ID tracker 253 can be configured with any number of buffers to accommodate the number of clock cycles it takes for any given I/O command. In some embodiments, the number of buffers in the ID tracker 253 can be configured on the fly to accommodate various I/O command processing durations.

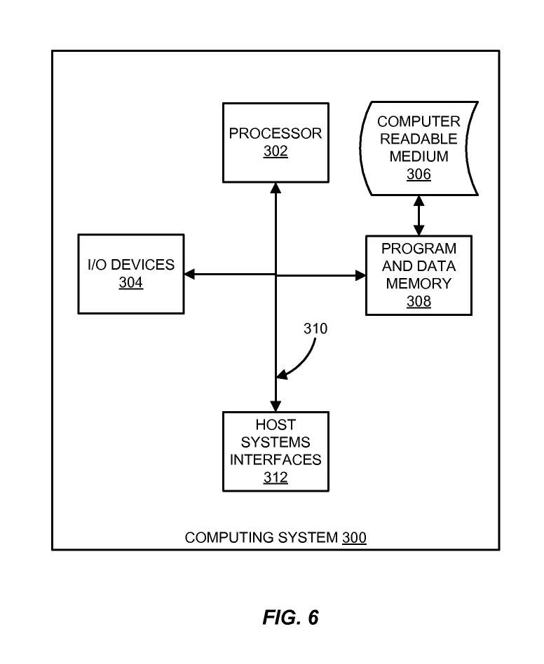

Additionally, the invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 6 illustrates a computing system 300 in which a computer readable medium 306 may provide instructions for performing any of the methods disclosed herein.

Furthermore, the invention can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computer system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 300, suitable for storing and/or executing program code, can include one or more processors 302 coupled directly or indirectly to memory 308 through a system bus 310. The memory 308 can include local memory employed during actual execution of the program code, bulk storage, and cache memories which provide temporary storage of at least some program code in order to reduce the number of times code is retrieved from bulk storage during execution. Input/output or I/O devices 304 (including but not limited to keyboards, displays, pointing devices, etc.) can be coupled to the system either directly or through intervening I/O controllers. Network adapters may also be coupled to the system to enable the computing system 300 to become coupled to other data processing systems, such as through host systems interfaces 312, or remote printers or storage devices through intervening private or public networks. Modems, cable modem and Ethernet cards are just a few of the currently available types of network adapters.

What is claimed is:

1. A memory device, comprising:
a memory;
slave logic operable to receive Input/Output (I/O) commands from a plurality of master components; and
a memory controller communicatively coupled to the slave interface and operable to process the I/O commands from the master components to operate on data in the memory,
wherein each I/O command comprises an identification (ID) assigned by its originating master component, and
wherein the slave logic is further operable to determine the ID of a first of the I/O commands from a first of the master components, to receive a second of the I/O commands from a second of the master components having a same ID as the first I/O command while the first I/O command is being processed by the memory controller, and to stall the second I/O command until the first I/O command is complete while allowing other I/O commands with other IDs to access the memory.

2. The memory device of claim 1, wherein:
the I/O commands are Advanced eXtensible Interface (AXI) I/O commands.

3. The memory device of claim 1, wherein:
the first and second I/O commands are read-modify-write commands.

4. The memory device of claim 1, further comprising:
an ID buffer operable to retain the ID of the first I/O command for a same number of clock cycles as used to complete the first I/O command.

5. The memory device of claim 1, further comprising:
a memory controller operable to process the first I/O command to a first location in the memory, to determine that the second I/O command is directed to the first memory location while the first I/O command is accessing the first memory location, and to stall the second I/O command until the first I/O command is complete while allowing a third I/O command to access the memory.

6. The memory device of claim 5, wherein:
the memory controller is further operable to extract an address of the memory location from the first I/O command, and to track the memory address until the first I/O command is complete.

7. The method of claim 5, wherein:
the command scheduler further comprises a state machine that is operable to extract a memory address of the second I/O command while the first I/O command is processing, and to compare the memory address of the second I/O command to the memory address extracted from the first I/O command.

8. A method operable in a memory device, comprising:
determining an identification (ID) of a first I/O command from a first master component;
processing the first I/O command to operate on data in the memory device;
receiving a second I/O command from a second master component having a same ID as the first I/O command while the first I/O command is operating on the data; and
until the first I/O command is complete, stalling the second I/O command while
allowing a third I/O command with a different ID to access the memory device,
wherein each ID of each I/O command is assigned by its originating master component.

9. The method of claim 8, wherein:
the I/O commands are Advanced eXtensible Interface (AXI) I/O commands.

10. The method of claim 8, wherein:
the first and second I/O commands are read-modify-write commands.

11. The method of claim 8, further comprising:
retaining the ID of the first I/O command for a same number of clock cycles as used to complete the first I/O command.

12. The method of claim 8, further comprising:
processing the first I/O command to a first location in the memory;
determining that the second I/O command is directed to the first memory location while the first I/O command is accessing the first memory location; and
stalling the second I/O command until the first I/O command is complete while allowing the third I/O command to access the memory.

13. The method of claim 12, further comprising:
extracting an address of the memory location from the first I/O command; and
tracking the memory address until the first I/O command is complete.

14. The method of claim 12, further comprising:
extracting a memory address of the second I/O command while the first I/O command is processing; and
comparing the memory address of the second I/O command to the memory address extracted from the first I/O command.

15. A non-transitory computer readable medium operable in a memory device that, when executed by logic in the memory device, directs the logic to:
determine an identification (ID) of a first I/O command from a first master component;
process the first I/O command to operate on data in the memory device;
receive a second I/O command from a second master component having a same ID as the first I/O command while the first I/O command is operating on the data; and
until the first I/O command is complete, stall the second I/O command while
allow a third I/O command with a different ID to access the memory device,
wherein each ID of each I/O command is assigned by its originating master component.

16. The computer readable medium of claim 15, wherein:
the first and second I/O commands are read-modify-write commands.

17. The computer readable medium of claim 15, further comprising instructions that direct logic to:
retain the ID of the first I/O command for a same number of clock cycles as used to complete the first I/O command.

18. The computer readable medium of claim 15, further comprising instructions that direct logic to:
process the first I/O command to a first location in the memory;
determine that the second I/O command is directed to the first memory location while the first I/O command is accessing the first memory location; and
stall the second I/O command until the first I/O command is complete while allowing the third I/O command to access the memory.

19. The computer readable medium of claim 18, further comprising instructions that direct logic to:
extract an address of the memory location from the first I/O command; and
track the memory address until the first I/O command is complete.

20. The computer readable medium of claim 18, further comprising instructions that direct logic to:
extract a memory address of the second I/O command while the first I/O command is processing; and
compare the memory address of the second I/O command to the memory address extracted from the first I/O command.
